(19) United States
(12) Patent Application Publication
(10) Pub. No.: US 2025/0329244 A1
(43) Pub. Date: Oct. 23, 2025

(54) DRAIN DETECTION SYSTEM WITH MULTI-ZONE ALERTS

(71) Applicant: Microshare Inc., Philadelphia, PA (US)

(72) Inventors: Ronald Rock, Philadelphia, PA (US); Charles Paumellle, Encamp (AD); Brendan Collins, Chalfont, PA (US)

(73) Assignee: Microshare Inc., Philadelphia, PA (US)

(21) Appl. No.: 19/187,566

(22) Filed: Apr. 23, 2025

Related U.S. Application Data
(60) Provisional application No. 63/637,679, filed on Apr. 23, 2024.

(51) Int. Cl. G08B 21/20; E04D 13/00; G08B 21/18

(52) U.S. Cl. CPC G08B 21/20; G08B 21/182; E04D 13/006

(57) ABSTRACT

A water backup detection system includes a slanted bar tapering from one edge to opposite edge, the slanted bar is segmented into a plurality of detection zones, and a sensor assembly, with a sensor correspondingly attached to each of the plurality of detection zones on the slanted bar. Further, the system has a housing, enclosing the slanted bar, having side slots for controlled water entry, the sensor assembly is configured to trigger an alert corresponding to a water level in the housing.

### FIELD OF THE INVENTION

The present disclosure is directed to water drainage systems and methods, more particularly to systems and methods of detecting water back up detection.

### BACKGROUND

Flat roofs are a common choice in construction because they are simpler to build and use fewer materials compared to sloped roofs. Their design makes them cost-effective and easier to install, especially on large or commercial buildings.

However, one major challenge with flat roofs is water drainage. Since flat roofs don't naturally shed water like sloped roofs, they rely on drains and slight slopes to direct water away. If these drains get clogged with debris (like leaves, dirt, or ice) or if the roof develops low spots due to settling or wear, water can pool on the surface.

Standing water creates several risks for flat roofs. First, excess weight becomes a concern—water is heavy, and large pools can add dangerous stress to the roof structure. Over time, trapped water can also seep through cracks, leading to leaks that damage insulation, ceilings, and even the building's interior. Additionally, constant moisture weakens roofing materials, causing cracks, damp decay, or rot development, which further compromises the surface's durability.

It is therefore an object of the invention to overcome the problem of handling the water drainage without risking the integrity of the surface.

### SUMMARY OF THE EMBODIMENTS

Embodiments of the present disclosure may include a water backup detection system, including a slanted bar tapering from one edge to opposite edge, the slanted bar may be segmented into a plurality of detection zones. Embodiments may also include a sensor assembly, with a sensor correspondingly attached to each of the plurality of detection zones on the slanted bar. Embodiments may also include a housing, enclosing the slanted bar, having side slots for controlled water entry. In some embodiments, the sensor assembly may be configured to trigger an alert corresponding to a water level in the housing.

In some embodiments, the slanted bar may be segmented into six detection zones, each zone indicating change in the water level. In some embodiments, the sensor assembly has six sensors corresponding to six detection zones, triggering zone-specific alerts as water reaches corresponding detection levels.

In some embodiments, the system may include a power source, configured to provide power to the sensor assembly and a wireless communication network and the power source is a portable battery unit, that is configured for modular deployment and automated real-time monitoring and alerting.

In some embodiments, the side slots of the housing may be configured to allow water to enter the housing only during backup conditions, maintaining the sensor assembly in a dry state under normal environmental circumstances. In some embodiments, the sensor assembly may be integrated with a wireless communication network, enabling remote transmission of water level data to a monitoring system.

Embodiments of the present disclosure may also include a method for detecting water backup, including placing a sensor assembly on a slanted bar with a multi-zone detection surface within a housing. Embodiments may also include allowing water to enter through side slots of the housing. Embodiments may also include triggering zone-specific alerts as water reaches corresponding detection levels.

Embodiments may also include each of the sensor of the sensor assembly triggers alert at different water accumulation levels in real time. In some embodiments, the method may include enabling remote transmission of water level data using a wireless communication network. In some embodiments, the sensor assembly may be integrated with the wireless communication network. In some embodiments, the method may include configuring a power source to provide power to the sensor assembly and a wireless communication network.

The sensor's design reduces false alarms from environmental factors, keeping it dry under normal conditions while accurately detecting water backups in real time. The features create a water detection system that overcomes the limitations of existing methods. It's advanced technology and innovative design provide reliable, efficient monitoring in various environments. The solution is both creative and practical, offering significant improvements over traditional approaches.

The water backup detection system offers comprehensive protection across multiple environments by identifying potential flooding and leaks before they cause significant damage. In residential settings, it safeguards roofs, basements and crawl spaces from water seepage due to heavy rainfall or plumbing failures, while also monitoring high-risk areas like bathrooms and kitchens for leaks under sinks, behind toilets, or near appliances such as dishwashers and washing machines.

For industrial and commercial applications, the system ensures reliable operation by detecting HVAC drain pan overflows, monitoring warehouse storage areas for water exposure, and preventing flooding in parking garages. Critical facilities like server rooms and data centers benefit from early warnings that prevent costly water damage to sensitive IT infrastructure.

In agriculture, it helps maintain optimal conditions by alerting users to drainage status in greenhouses, hydroponic setups, and irrigation systems, while also supporting environmental conservation through wetland and floodplain monitoring.

Municipal and infrastructure applications include preventing sewer backups, monitoring bridges and tunnels for flood risks, and ensuring safe drainage in public pools and water parks. Marine uses range from bilge water detection in boats to dock and pier monitoring, protecting against structural water damage.

Additionally, smart home integration enables real-time alerts through platforms like Alexa and Google Home, allowing for quick response to potential threats. The system also serves as a valuable tool for insurance risk mitigation, providing documented evidence of water incidents to support claims. By offering proactive, real-time monitoring across diverse environments, this technology significantly reduces water drainage failure related risks and associated costs.

By automating the detection of water backup, the system reduces the need for manual roof inspections, saving both labor hours and fuel costs associated with dispatching workers for on-site inspections. This contributes to overall operational cost savings.

### BRIEF DESCRIPTION OF THE DRAWINGS

FIG. 1 is a schematic overview that depicts a water backup detection system, according to some embodiments of the present disclosure.

FIG. 2 is a perspective view that depicts a water backup detection system, according to some embodiments of the present disclosure.

FIG. 3 is a cross-sectional top view that depicts a water backup detection system, according to some embodiments of the present disclosure.

FIG. 4a is a cross-sectional side view that depicts a water backup detection system, according to some embodiments of the present disclosure.

FIG. 4b is a cross-sectional back view that depicts a water backup detection system, according to some embodiments of the present disclosure.

FIG. 5 is a view that depicts a sensor of a water backup detection system, according to some embodiments of the present disclosure.

FIG. 6 is a high-level logic flow diagram of an illustrative method for detecting water backup in a water backup detection system, according to some embodiments of the present disclosure.

### DETAILED DESCRIPTION OF THE EMBODIMENTS

The present disclosure relates to a wireless battery-operated remote water backup detection system designed to detect and measure varying levels of water accumulation in flat surfaces. The water backup detection system consists of a PVC vinyl enclosure that houses a sensor surface segmented into multiple zones. The primary purpose of this system is to detect and measure water accumulation in real-time by utilizing a multi-zone alert system. The sensor surface is divided into six distinct zones, each calibrated to trigger an alert when a specific level of water accumulation is detected. This segmentation enables the system to provide detailed insights into the extent of water backup, from the initial presence of water to deeper accumulations.

The system's sensors are powered by a reliable and long-lasting power source, and wireless communication. This ensures that the system can send alerts to a remote monitoring system without the need for extensive wiring or manual inspections, thus facilitating easy installation and continuous monitoring of roof conditions.

The enclosure is designed with side slots that allow water to flow into the unit when backup conditions occur. Under normal conditions, the sensor remains dry and does not trigger false alarms, thanks to the protective design of the enclosure. The PVC material is durable, resistant to environmental factors such as sunlight and rain, and facilitates heat dissipation, ensuring that the system operates efficiently under a wide range of weather conditions.

The enclosure's design also maximizes the sensor's ability to detect water in a controlled manner. Water can only enter the enclosure when it accumulates beyond a certain threshold, triggering the sensor's alert system. This minimizes environmental interference and ensures that the sensor is activated only during a water backup event, providing reliable detection and reducing the likelihood of false alerts.

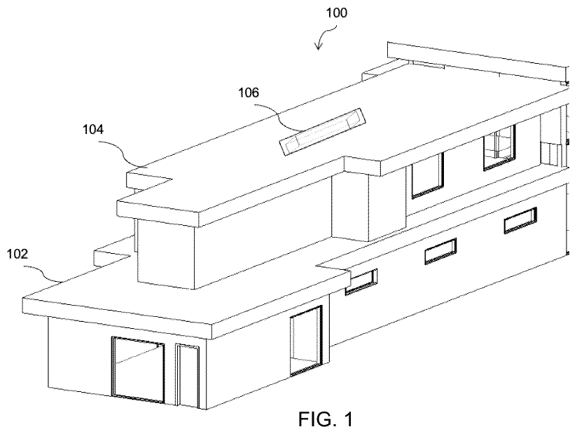

FIG. 1 is a schematic overview that depicts an illustrative water backup detection enabled environment 100 consistent with at least one example of the present disclosure. The water backup detection enabled environment 100 may generally include one or more water backup detection systems 106. Each of the water backup detection system 106 may be disposed to form a regular or irregular pattern of drainage on a roof 104 of a building 102 and is connected to one or more drainages to allow water to drain from the roof 104. At least one detection sensor may be associated with a water backup detection system 106.

Each of the water backup detection system 106 may include a sensor assembly, with at least one detection sensor correspondingly attached to a detection zone in the water backup detection system 106. The water backup detection system 106 may also include a housing. The housing may include side slots for controlled water entry. The sensor assembly may be configured to trigger an alert corresponding to a water level in the housing.

The water backup detection system 106 saves labor hours by automating roof inspections enhances safety by minimizing the need for manual roof assessments, reduces fuel consumption by eliminating the necessity of sending workers to sites, and mitigates water damage risks by providing early detection and alerts for potential water backup issues.

The water backup detection system 106 is versatile and suitable for use on flat rooftops, surfaces and outside patios in multi-family high-rise buildings offers adaptable water monitoring and detection solutions in diverse residential and commercial settings.

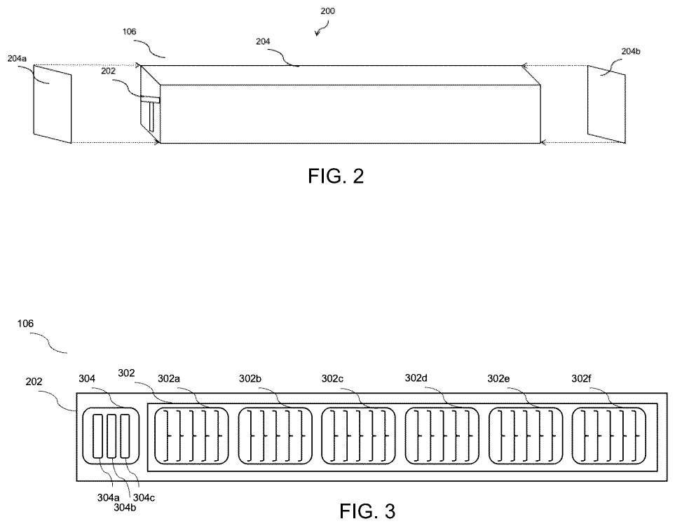

FIG. 2 is a perspective view 200 that depicts the water backup detection system 106 in accordance with at least one example of the present disclosure. The water backup detection system 106 has a housing enclosure 204 with side slots 204a, 204b. The housing enclosure 204 has the side slots 204a, 204b for controlled water entry into the water backup detection system 106. The housing enclosure 204 has at least one slanted bar 202 having a sensor assembly and a control system.

The housing enclosure 204 is a PVC vinyl enclosure with strategically placed side slots 204a, 204b for water flow, heat dissipation, and protection from environmental factors. Water can only enter the sensor housing when it drains back up, flowing through the side slots into where the sensor is housed. It demonstrates a unique design approach for maximizing sensor protection, operational efficiency and minimizing false alerts. This design ensures that the sensors remain dry under normal conditions and only triggers alarms upon detecting water backup through the allocated side slots. The segmented zones on the sensor surface operate within the PVC vinyl sleeve to trigger alerts at different water accumulation levels. This provides precise detection and measurement of water backups in real-time.

FIG. 3 is a cross-sectional top view of the water backup detection system 106, according to some embodiments of the present disclosure. The illustration depicts a top view of the slanted bar 202. The slanted bar 202 has a sensor assembly 302, with a plurality of sensors 302a, 302b, 302c, 302d, 302e, and 302f, as shown. The sensor assembly 302 can have as many sensors as required. The slanted bar 202 has a control system 304, the control system 304 has a power module 304a, a communication module 304b, and a monitoring module 304c. In one example, the slanted bar 202 is placed inside the housing enclosure 204.

The sensor assembly 302, with the plurality of sensors on the slanted bar 202 is designed to measure varying detection levels of water accumulation in flat roofs. The sensor zones operate based on a pre-determined threshold for water depth, which is set to trigger alerts as the water level rises within the designated zones in real time. Each zone is equipped with a separate detection level mechanism that triggers an alert when water reaches the designated detection level for that zone. The alerts, based on water level data, progress in intensity and significance as water accumulates in deeper layers of the system. This segmentation provides an effective and detailed means of monitoring water backup, enabling users to understand both the presence and the extent of water buildup. For example, Zone 1 may indicate the initial presence of water, while Zone 6 may signal a deeper water backup, which could potentially lead to structural damage if left unaddressed.

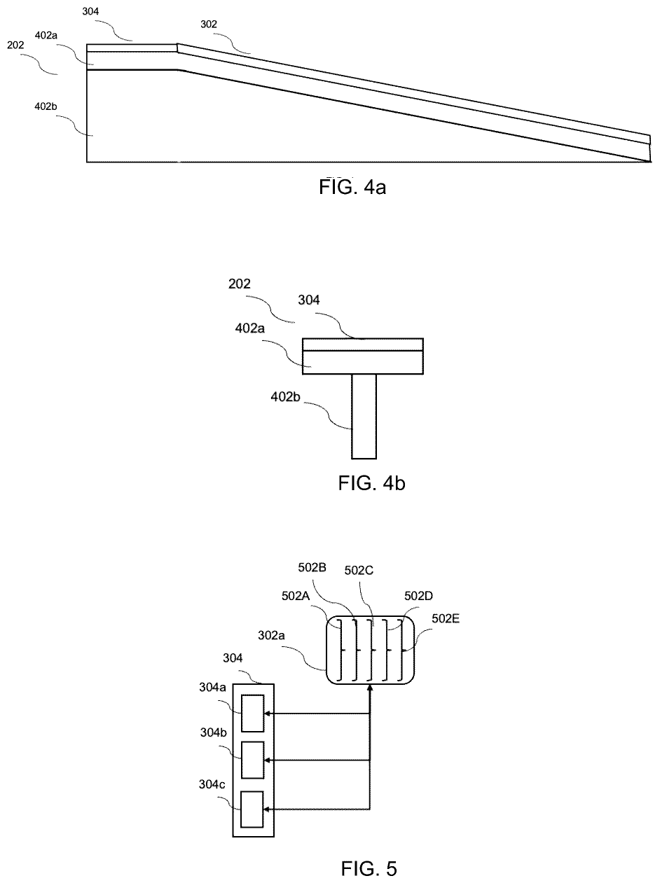

FIG. 4a is a cross-sectional side view of the water backup detection system 106, according to some embodiments of the present disclosure. The illustration depicts a side view of the slanted bar 202. The slanted bar 202 tapers from one end/edge of the slanted bar to opposite end/edge of the slanted bar. The slanted bar 202 has an upper section 402a that is flat and is like a plate supporting the sensor assembly 302, with a plurality of sensors, and the control system 304, with the power module 304a, the communication module 304b, and the monitoring module 304c. The slanted bar 202 has a lower section 402b that is more like a pillar support for the whole of the upper section 402a. In one example, the slanted bar 202, has the sensor assembly 302 and the control system 304 fixed on the top and is placed inside the housing enclosure 204.

In one embodiment, a water backup detection device comprises a PVC vinyl housing with a multi-zone sensor surface. The device features a ¾-inch-thick slanted bar cut on an angle, with a height tapering from 3.5 inches to 0 inches from one edge of the slanted bar to opposite edge of the slanted bar, providing a unique design for precise water detection level. Each zone of the sensor surface triggers alerts when wet, with initial zones indicating the presence of some water backup and subsequent zones signaling deeper water levels. This functionality allows the system to provide detailed insights into the extent of water accumulation with high accuracy.

FIG. 4b is a cross-sectional back view of the water backup detection system 106, according to some embodiments of the present disclosure. The illustration depicts a back view of the slanted bar 202. The slanted bar 202 is shown with the flat upper section 402a supporting the control system 304, the sensor assembly 302 would not be visible from the back view. The slanted bar 202 is shown with the pillar lower section 402b to support the upper section 402a and forming a T shaped structure.

FIG. 5 depicts a sensor 302a of the water backup detection system 106, according to some embodiments of the present disclosure. The sensor 302a is part of the sensor assembly 302 and is similar to other sensors 302b, 302c, 302d, 302e, and 302f of the sensor assembly 302. The sensor 302a has sensor tape or sensor marking as sensor reading scales at 502A, 502B, 502C, 502D, and 502E. The sensor 302a can have any number of markings or reading scales in the sensor assembly 302.

The sensor 302a, like other sensors 302b, 302c, 302d, 302e, and 302f of the sensor assembly 302, is connected to the control system 304. The sensor 302a, like other sensors 302b, 302c, 302d, 302e, and 302f of the sensor assembly 302, is connected to the power module 304a. The power module 304a provides power to the sensor 302a and the other sensors. The sensor markings act as contact points-when water touches them, they trigger a signal to the control system in real time.

In one example, the sensor system is powered by a sustainable, self-contained, modular, easy- to-install, long-life battery system integrated with Microshare technology, providing a power source that can last for two to three years. This ensures that the system operates continuously over an extended period without the need for frequent battery replacements, further simplifying the maintenance and operation of the system.

The sensor 302a, like other sensors 302b, 302c, 302d, 302e, and 302f of the sensor assembly 302, is connected to the communication module 304b. The communication module 304b provides a wireless communication network to the sensor 302a and the other sensors and reads the water level data in real time.

The system incorporates wireless communication via LoRa (Long Range) technology, which enables the sensors to transmit real-time data to a remote monitoring system or user interface. This wireless capability eliminates the need for manual inspections, allowing building managers or property owners to monitor the system remotely and take proactive actions when necessary. The wireless communication by the communication module 304b is powered by the power module 304a.

The sensor 302a, like other sensors 302b, 302c, 302d, 302e, and 302f of the sensor assembly 302, is connected to the monitoring module 304c. The monitoring module 304c monitors the functioning of the sensor 302a and the other sensors.

The monitoring module 304c provides real-time monitoring of water accumulation, enabling early detection of water backup issues before they become severe. This early warning capability helps prevent potential damage to the roof structure, thus reducing the risk of costly repairs and minimizing water damage. The monitoring module 304c shares the alerts by using the communication module.

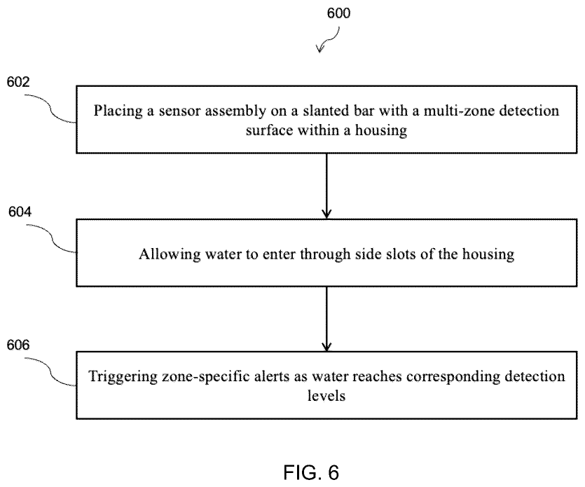

FIG. 6 is a high-level logic flow diagram 600 of an illustrative method for detecting water backup in the water backup detection system 106, according to some embodiments of the present disclosure.

In some embodiments, at 602, the method may include placing a sensor assembly 302 on a slanted bar 202 with a multi-zone detection surface within a housing 204. At 604, the method may include allowing water to enter through side slots 204a, 204b of the housing 204. At 606, the method may include triggering zone-specific alerts as water reaches corresponding detection levels. In some embodiments, each of the sensor 302a, 302b, 302c, 302d, 302e, and 302f of the sensor assembly 302 triggers alert at different water accumulation levels in real time. In some embodiments, the method may include enabling remote transmission of water level data using a wireless communication network 304b. The sensor assembly 302 may be integrated with the wireless communication network 304b. In some embodiments, the method may include configuring a power source 304a to provide power to the sensor assembly 302 and a wireless communication network 304b.

While the invention has been described with reference to the embodiments above, a person of ordinary skill in the art would understand that various changes or modifications may be made thereto without departing from the scope of the claims.

We claim:

1. A water backup detection system, comprising:
a slanted bar tapering from one edge to opposite edge, the slanted bar is segmented into a plurality of detection zones;
a sensor assembly, with a sensor correspondingly attached to each of the plurality of detection zones on the slanted bar; and
a housing, enclosing the slanted bar, having side slots for controlled water entry, wherein the sensor assembly is configured to trigger an alert corresponding to a water level in the housing.

2. The system of claim 1, wherein the slanted bar is segmented into six detection zones, each zone indicating change in the water level in real time.

3. The system of claim 1, wherein the sensor assembly has six sensors corresponding to six detection zones, triggering zone-specific alerts as water reaches corresponding detection levels.

4. The system of claim 1, further comprising a power source, configured to provide power to the sensor assembly and a wireless communication network.

5. The system of claim 4, wherein the power source is a portable battery unit, and the portable battery unit is configured for modular deployment and automated real-time monitoring and alerting.

6. The system of claim 1, wherein the side slots of the housing are configured to allow water to enter the housing only during backup conditions, maintaining the sensor assembly in a dry state under normal environmental circumstances.

7. The system of claim 1, wherein the sensor assembly is integrated with a wireless communication network, enabling remote transmission of water level data to a monitoring system.

8. A method for detecting water backup, comprising:
placing a sensor assembly on a slanted bar with a multi-zone detection surface within a housing;
allowing water to enter through side slots of the housing; and
triggering zone-specific alerts as water reaches corresponding detection levels.

9. The method of claim 8, wherein each of the sensor of the sensor assembly triggers alert at different water accumulation levels in real time.

10. The method of claim 8, further comprising enabling remote transmission of water level data using a wireless communication network, wherein the sensor assembly is integrated with the wireless communication network.

11. The method of claim 8, further comprising configuring a power source to provide power to the sensor assembly and a wireless communication network.
